(19) United States
(12) Patent Application Publication
(10) Pub. No.: US 2026/0225384 A1
(43) Pub. Date: Aug. 6, 2026

(54) PRINTER, METHOD, AND STORAGE MEDIUM

(71) Applicant: Toshiba Tec Kabushiki Kaisha, Tokyo (JP)

(72) Inventor: Noriyuki WATANABE, Mishima Shizuoka (JP)

(21) Appl. No.: 19/353,571

(22) Filed: Oct. 8, 2025

(30) Foreign Application Priority Data
Feb. 3, 2025 (JP) 2025-015802

(51) Int. Cl. B41J 15/04; G06F 3/12

(52) U.S. Cl. CPC B41J 15/042; G06F 3/1205; G06F 3/1296

(57) ABSTRACT

A printer includes a roller that conveys a recording medium; a motor that rotates the roller; a print head that prints receipts on the recording medium conveyed by the roller; a storage device that stores receipt length information including receipt lengths of a predetermined number of printed receipts; a memory; and a processor configured to execute a program that is stored in the memory to perform the steps of: calculating a representative receipt length based on the receipt lengths in the receipt length information, determining a maximum conveying speed of the recording medium for a receipt to be printed based on the representative receipt length, and controlling the motor to rotate the roller to convey the recording medium based on the maximum conveying speed.

### CROSS-REFERENCE TO RELATED APPLICATION

This application is based upon and claims the benefit of priority from Japanese Patent Application No. 2025-015802, filed Feb. 3, 2025, the entire contents of which are incorporated herein by reference.

### FIELD

Embodiments described herein relate generally to a printer, a method, and a storage medium.

### BACKGROUND

For example, in a known thermal receipt printer, printing is performed while varying the conveying speed of a receipt between the maximum speed and the minimum speed according to the print density of each raster in the conveyance direction (or the sub-scanning direction) of the receipt so that the conveying speed conforms to a given power supply specification. Also, the printing speed of each raster is determined based on the amount of data (or the number of dots) in the main-scanning direction. With this configuration, because even a short receipt is printed at high speed, the load on the print head increases, and the lifetime of the print head decreases.

On the other hand, to reduce the wait time for printing a receipt, it is desirable to reduce the print time of a receipt as far as possible.

### SUMMARY OF THE INVENTION

Embodiments of this disclosure provide a printer, a method, and a storage medium that make it possible to reduce the print time of a receipt and increase the lifetime of a print head.

According to an aspect of this disclosure, a printer includes a roller that conveys a recording medium; a motor that rotates the roller; a print head that prints receipts on the recording medium conveyed by the roller; a storage device that stores receipt length information including receipt lengths of a predetermined number of printed receipts; a memory; and a processor configured to execute a program that is stored in the memory to perform the steps of: calculating a representative receipt length based on the receipt lengths in the receipt length information, determining a maximum conveying speed of the recording medium for a receipt to be printed based on the representative receipt length, and controlling the motor to rotate the roller to convey the recording medium based on the maximum conveying speed.

### BRIEF DESCRIPTION OF THE DRAWINGS

FIG. 1 is a cross-sectional view of an internal structure of a receipt printer according to an embodiment.

FIG. 2 is a diagram illustrating an example of a receipt printed by the receipt printer.

FIG. 3 is a hardware block diagram illustrating an example of a hardware configuration of the receipt printer.

FIG. 4 is an example of a receipt length recording table stored in the receipt printer.

FIG. 5 is an example of a maximum printing speed determination table stored in the receipt printer.

FIG. 6 is a graph for describing an example of a method performed by the receipt printer to determine a printing speed according to an average receipt length and the number of dots in the main-scanning direction.

FIG. 7 is a functional block diagram illustrating an example of a functional configuration of the receipt printer.

FIG. 8 is a flowchart illustrating an example of a process performed by the receipt printer.

### DETAILED DESCRIPTION

Hereinafter, a receipt printer according to an embodiment of this disclosure will be described in detail with reference to the accompanying drawings.

### Overall Configuration of Receipt Printer

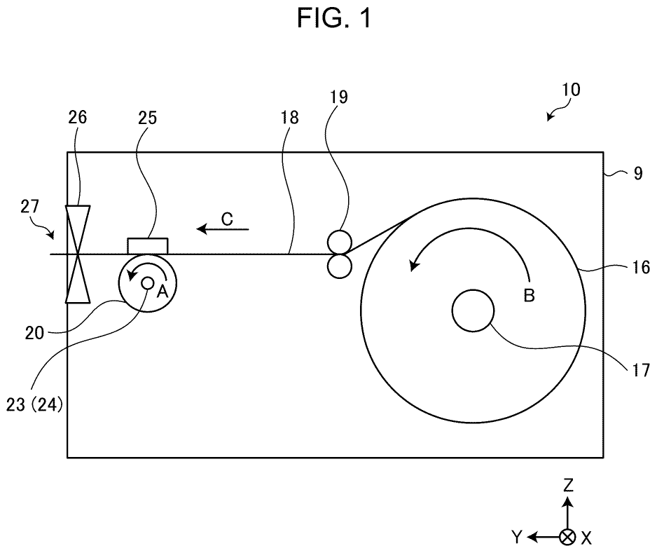

A schematic configuration of a receipt printer 10 according to the present embodiment will be described with reference to FIG. 1. FIG. 1 is a cross-sectional view of an example of an internal structure of the receipt printer 10. The receipt printer 10 is an example of a printer according to the present disclosure.

The receipt printer 10 prints information on a receipt sheet 18 being fed from a sheet roll 16 wound around a roll core 17. The receipt sheet 18 is an example of a recording medium.

The receipt printer 10 includes conveyance rollers 19, a platen roller 20, a thermal head 25, and a cutter 26 that are disposed in a housing 9.

The conveyance rollers 19 are free rollers that form a conveyance path for guiding the receipt sheet 18 fed from the sheet roll 16 toward the thermal head 25 as indicated by an arrow C.

The platen roller 20 is rotated in a direction indicated by an arrow A about a shaft 24 by the driving force of a platen roller drive motor 23 and thereby feeds the receipt sheet 18 from one end of the sheet roll 16 in a direction indicated by an arrow B. The receipt sheet 18 is conveyed toward the thermal head 25. The platen roller 20 is an example of a roller, and the platen roller drive motor 23 is an example of a motor.

The thermal head 25 includes multiple (for example, 640) heating elements that are arranged in a line in a direction orthogonal to the conveyance direction of the receipt sheet 18. The thermal head 25 is pressed against the platen roller 20. The receipt sheet 18 is conveyed toward a sheet discharge slot 27 while being sandwiched between the thermal head 25 and the platen roller 20. The thermal head 25 performs printing on the front surface (or a surface facing the positive Z-axis direction in FIG. 1) of the receipt sheet 18 sandwiched between the thermal head 25 and the platen roller 20 by causing the heating elements corresponding to a printing pattern to generate heat. The thermal head 25 is an example of a print head.

The cutter 26 cuts off the receipt sheet 18 that is discharged from the sheet discharge slot 27 after information is printed on the receipt sheet 18. The cutter 26 is driven by a motor (not shown) to cut off the receipt sheet 18 discharged from the sheet discharge slot 27.

### Example of Receipt Printed by Receipt Printer

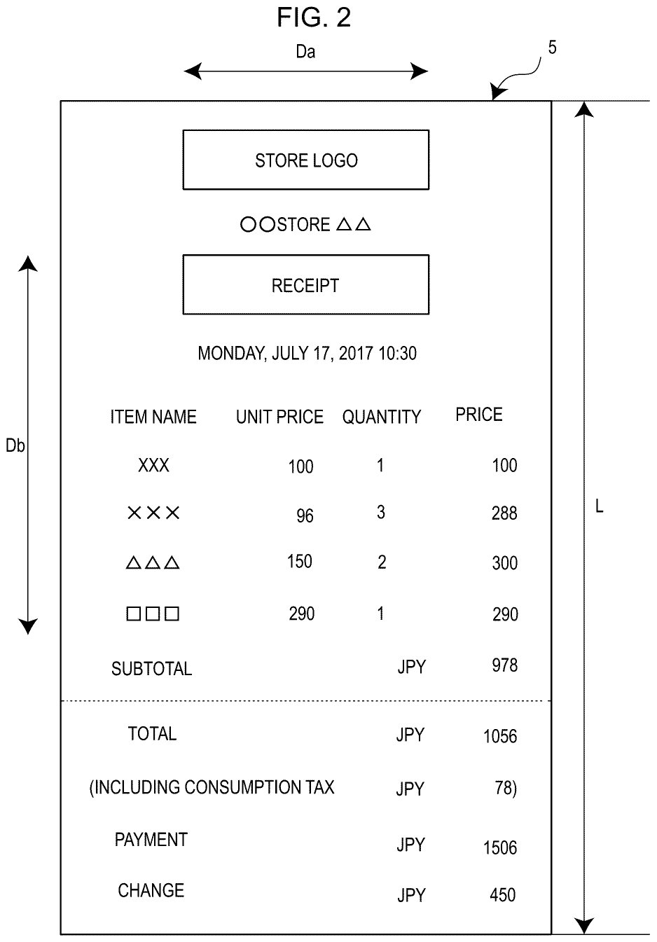

An example of a receipt 5 printed by the receipt printer 10 will be described with reference to FIG. 2. FIG. 2 is a diagram illustrating an example of the receipt 5 printed by the receipt printer 10 according to the embodiment.

As shown in FIG. 2, a store logo, a store name, issue date and time, an item name, a unit price, a quantity, a price, a subtotal, a total, a consumption tax, a payment, a change, and the like are printed on the receipt 5 according to items purchased by a customer.

The item name, the unit price, the quantity, and the price (which are collectively referred to as item price information) are printed for each item along a main-scanning direction Da, which is the width direction of the receipt sheet 18. The main-scanning direction Da coincides with the longitudinal direction of the thermal head 25 of the receipt printer 10.

The store logo, the store name, the issue date and time, the item price information, the subtotal, the total, the consumption tax, the payment, and the change are printed along the longitudinal direction of the receipt 5 with line feeds placed at the right end in the width direction of the receipt sheet 18. The longitudinal direction of the receipt 5 is referred to as a sub-scanning direction Db. The receipt 5 is conveyed in the sub-scanning direction Db in accordance with the rotation of the platen roller 20. In the present embodiment, the conveying speed, which is the speed at which the receipt 5 is conveyed in the sub-scanning direction Db, is also referred to as the printing speed of the receipt printer 10.

That is, the receipt printer 10 prints each line in the main-scanning direction Da by using the thermal head 25 while conveying the receipt sheet 18 in the sub-scanning direction Db at a predetermined conveying speed (printing speed).

Each receipt 5 printed by the receipt printer 10 has a receipt length L that corresponds to the number of items purchased by the customer. When printing the receipt 5, the receipt printer 10 calculates the receipt length L by totaling the amounts of the receipt sheet 18 conveyed for each line (or raster) of the receipt 5.

### Hardware Configuration of Receipt Printer

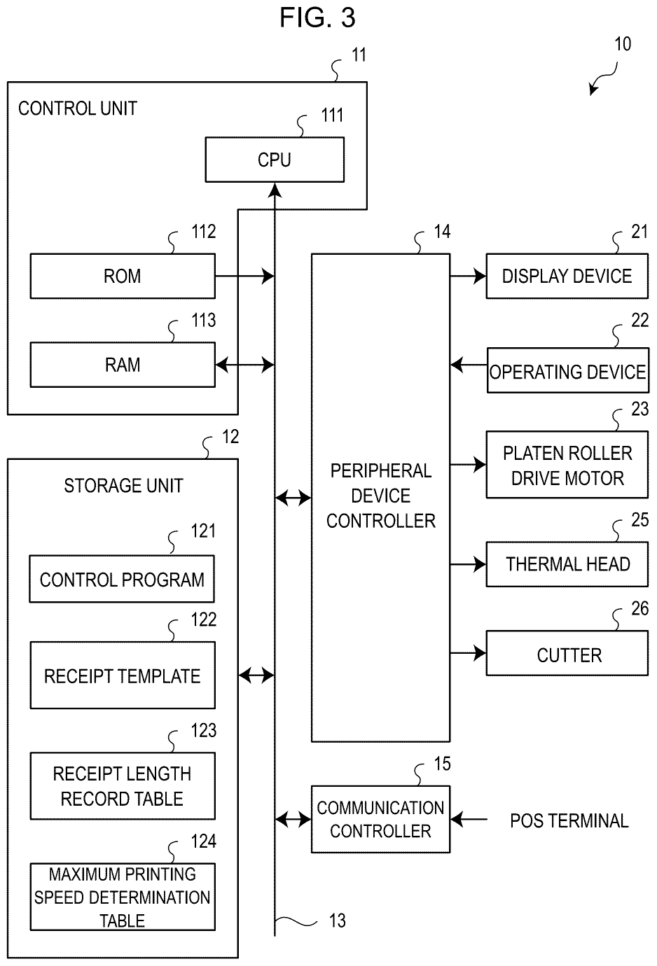

An example of a hardware configuration of the receipt printer 10 will be described with reference to FIG. 3. FIG. 3 is a hardware block diagram illustrating an example of a hardware configuration of the receipt printer 10 according to the embodiment.

As shown in FIG. 3, the receipt printer 10 includes a control unit 11, a storage unit 12, a peripheral device controller 14, and a communication controller 15 that are connected to each other via an internal bus 13.

The control unit 11 controls the overall operation of the receipt printer 10. The control unit 11 includes a CPU (Central Processing Unit) 111, a ROM (Read-Only Memory) 112, and a RAM (Random Access Memory) 113. The CPU 111 is connected to the ROM 112 and the RAM 113 via an internal bus, such as an address bus or a data bus. The CPU 111 loads various programs stored in the ROM 112 and the storage unit 12 into the RAM 113. The CPU 111 controls the operation of the receipt printer 10 by operating in accordance with the various programs loaded into the RAM 113. In other words, the control unit 11 has the configuration of a typical computer. The CPU 111 is an example of a processor.

The storage unit 12 is a storage device, such as a hard disk drive (HDD) or a solid state drive (SSD). The storage unit 12 may also be a non-volatile memory, such as a flash memory, that retains stored information even when the power is turned off. The storage unit 12 stores a control program 121, a receipt template 122, a receipt length record table 123, and a maximum printing speed determination table 124. Each of the RAM 113 and the storage unit 12 is an example of a memory.

The control program 121 is a program for controlling the overall operation of the receipt printer 10. The control program 121 may be stored in the storage unit 12 or may be recorded in a non-transitory computer-readable storage medium, such as a compact disk read-only memory (CD-ROM), a flexible disk (FD), a CD-recordable (CD-R), or a digital versatile disk (DVD), in an installable format or an executable format. The control program 121 may also be stored in a computer connected to a network and downloaded via the network. Furthermore, the control program 121 may be distributed via a network such as the Internet.

The receipt template 122 is layout data of the receipt 5. The receipt template 122 includes a store logo, a store name, and the like.

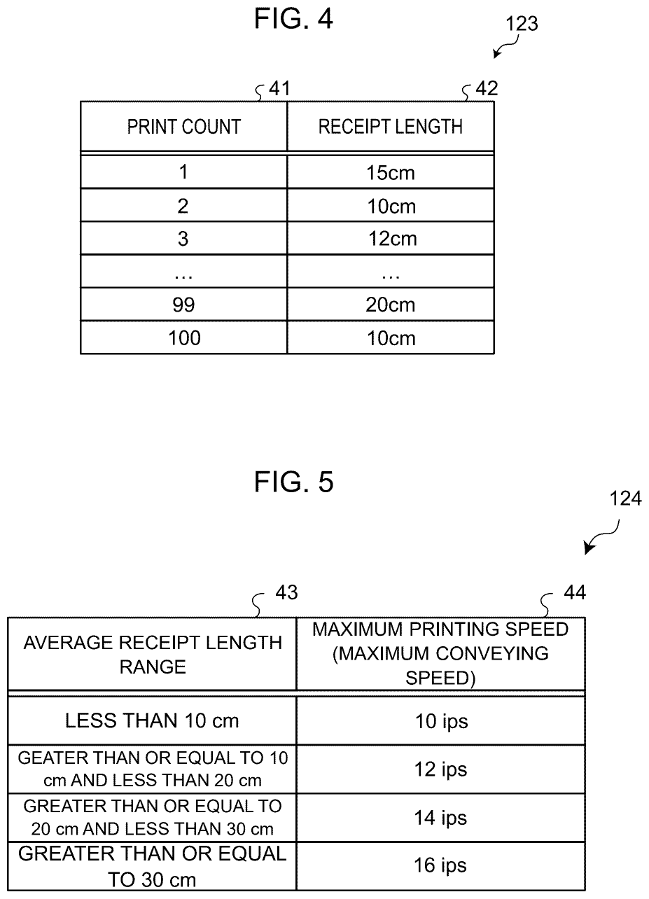

The receipt length record table 123 is a file that records the receipt lengths L of a predetermined number of receipts 5 printed by the receipt printer 10 in the past. The receipt length record table 123 is an example of receipt length information. The receipt length record table 123 will be described in detail later (see FIG. 4).

The maximum printing speed determination table 124 is a master file that stores maximum printing speeds at which the receipt printer 10 prints receipts 5 in association with average receipt length ranges 43 specifying the ranges of the mean value of the receipt lengths of a predetermined number of receipts 5 printed by the receipt printer 10 in the past. The maximum printing speed determination table 124 is an example of maximum conveying speed information including maximum conveying speeds that are associated with representative receipt length ranges specifying ranges of a representative receipt length. The maximum printing speed determination table 124 will be described in detail later (see FIG. 5).

The control unit 11 is connected to various input/output devices, such as a display device 21, an operating device 22, the platen roller drive motor 23, the thermal head 25, and the cutter 26, via a peripheral device controller 14. The display device 21 displays various types of information related to the operation of the receipt printer 10 and various operation screens. The display device 21 is, for example, a liquid crystal display (LCD) panel or an organic electroluminescence (EL) panel. The operating device 22 receives various instructions for the receipt printer 10. The operating device 22 is, for example, a touch panel disposed on the display device 21. The operating device 22 may also be physical switches. The platen roller drive motor 23, the thermal head 25, and the cutter 26 are described above.

The control unit 11 is connected to a POS terminal (not shown) via a communication controller 15. The POS terminal is an example of a host device. The receipt printer 10 obtains item transaction information to be printed on the receipt 5 from the POS terminal. The item transaction information includes item names, unit prices, quantities, prices, a subtotal, a total, and a consumption tax for items purchased by a customer. The receipt printer 10 also obtains payment-related information, such as a payment and a change, from the POS terminal.

### Data Structure of Receipt Length Record Table

An example of a data structure of the receipt length record table 123 will be described with reference to FIG. 4. FIG. 4 is an example of the receipt length record table 123 stored in the receipt printer 10 according to the embodiment.

The storage unit 12 of the receipt printer 10 stores the receipt length record table 123 shown in FIG. 4.

The receipt length record table 123 stores receipt lengths 42 in association with print counts 41.

Each print count 41 indicates the cumulative number of printed receipts 5.

Each receipt length 42 indicates the length of a printed receipt 5. The receipt printer 10 measures the number of rasters printed on each receipt 5, and calculates the receipt length 42 by multiplying the measured number of rasters by the conveyance distance corresponding to one raster.

The receipt printer 10 of the present embodiment stores up to 100 latest printing results of the receipts 5. The number of receipt lengths 42 (or the number of printing results) stored in the receipt printer 10 may be changed as appropriate.

When a receipt 5 is newly printed, the receipt printer 10 replaces the oldest receipt length 42 stored in the receipt length record table 123 with the latest receipt length 42, thereby updating the receipt length record table 123.

### Data Structure of Maximum Printing Speed Determination Table

An example of a data structure of the maximum printing speed determination table 124 will be described with reference to FIG. 5. FIG. 5 illustrates an example of a data structure of the maximum printing speed determination table 124.

The maximum printing speed determination table 124 stores average receipt length ranges 43 specifying the ranges of the mean value (which is hereafter referred to as “average receipt length”) of the receipt lengths 42 stored in the receipt length record table 123 in association with maximum printing speeds 44 at which the receipt printer 10 prints the receipt 5.

Each maximum printing speed 44 corresponds to the maximum conveying speed at which the platen roller 20 conveys the receipt sheet 18 when the receipt printer 10 prints the receipt 5.

For example, when the average receipt length is less than 10 cm, the receipt printer 10 conveys the receipt sheet 18 at a maximum conveying speed of 10 ips (inches/sec).

When the average receipt length is greater than or equal to 10 cm and less than 20 cm, the receipt printer 10 conveys the receipt sheet 18 at a maximum conveying speed of 12 ips.

When the average receipt length is greater than or equal to 20 cm and less than 30 cm, the receipt printer 10 conveys the receipt sheet 18 at a maximum conveying speed of 14 ips.

When the average receipt length is greater than or equal to 30 cm, the receipt printer 10 conveys the receipt sheet 18 at a maximum conveying speed of 16 ips.

In this way, the receipt printer 10 automatically reduces the conveying speed as the average receipt length decreases. This makes it possible to limit an increase in power consumption resulting from high-speed printing and reduce the load on the thermal head 25 and thereby makes it possible to extend the lifetime of the thermal head 25. Because the average receipt length is relatively short when the conveying speed of the receipt sheet 18 is reduced by this function, the performance of the entire printing is not greatly affected. The maximum conveying speeds (or maximum printing speeds) shown in FIG. 5 are examples and are not intended to limit this disclosure.

### Method of Determining Printing Speed (Conveying Speed) of Receipt Printer

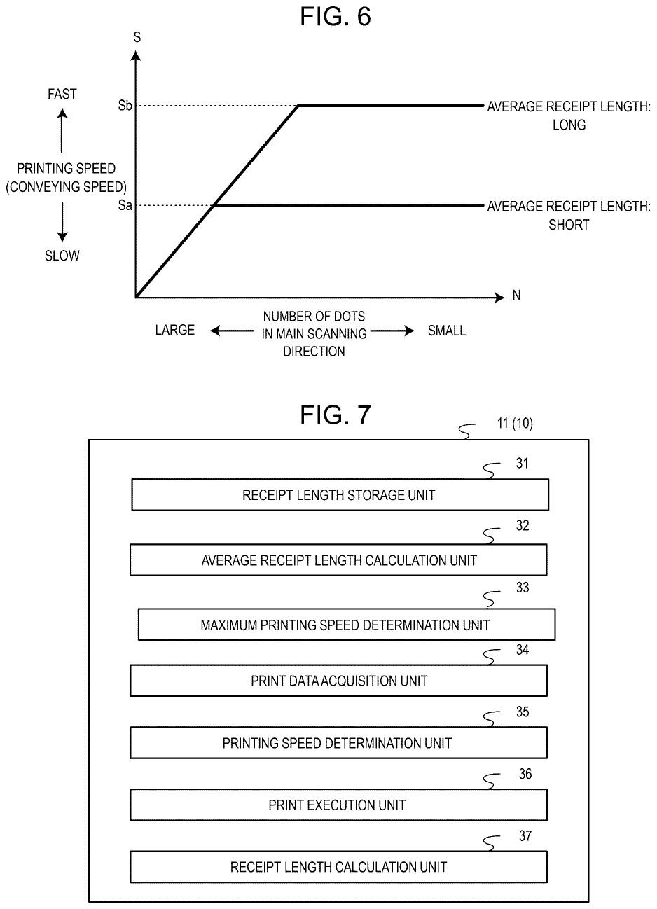

A method of determining the speed of printing the receipt 5 by the receipt printer 10 according to the present embodiment will be described with reference to FIG. 6. FIG. 6 is a graph for describing a method performed by the receipt printer 10 to determine a printing speed according to the average receipt length and the number of dots in the main-scanning direction.

The receipt printer 10 of the present embodiment determines the printing speed of the receipt 5 for each line (or each raster) according to the maximum printing speed 44 determined based on the average receipt length described above and the number of print dots (or dots to be printed) along the main-scanning direction Da.

The receipt printer 10 first calculates an average receipt length by averaging the receipt lengths 42 recorded in the receipt length record table 123.

Then, the receipt printer 10 determines a maximum printing speed (maximum conveying speed) corresponding to the calculated average receipt length based on the maximum printing speed determination table 124. In the example shown in FIG. 6, when the average receipt length 43 is long, the receipt printer 10 determines that the maximum printing speed (maximum conveying speed) is Sb. On the other hand, when the average receipt length 43 is short, the receipt printer 10 determines that the maximum printing speed (maximum conveying speed) is Sa. Here, Sb>Sa.

Next, the receipt printer 10 analyzes each line (or each raster) of print data and calculates the number of print dots N in each line (or each raster). As the number of print dots N in a line (or each raster) increases, the number of black dots in the line increases. That is, the number of print dots N is largest when a black line is drawn along the main-scanning direction Da (see FIG. 2).

As the number of print dots N in the main-scanning direction Da increases, the receipt printer 10 decreases the maximum printing speed (maximum conveying speed) that is determined when the average receipt length 43 is long so as not to be lower than the maximum printing speed that is determined when the average receipt length 43 is short. Thus, as shown in FIG. 6, in a region where the number of print dots N in the main-scanning direction Da is large, the receipt printer 10 monotonously increases the printing speed (or conveying speed) S within the range not exceeding the determined maximum printing speed (maximum conveying speed) as the number of print dots N in the main-scanning direction Da decreases. The slope of the printing speed (conveying speed) S in this region may be set as appropriate based on the power consumption of the receipt printer 10, the specification of the thermal head 25, and the like.

With the above configuration, the receipt printer 10 qualitatively sets the printing speed (conveying speed) S of the receipt sheet 18 as shown in FIG. 6.

### Functional Configuration of Receipt Printer

An example of a functional configuration of the receipt printer 10 will be described with reference to FIG. 7. FIG. 7 is a functional block diagram illustrating an example of a functional configuration of the receipt printer 10 according to the embodiment.

The control unit 11 of the receipt printer 10 loads the control program 121 into the RAM 113 and executes the loaded control program to implement functional units including a receipt length storage unit 31, an average receipt length calculation unit 32, a maximum printing speed determination unit 33, a print data acquisition unit 34, a printing speed determination unit 35, a print execution unit 36, and a receipt length calculation unit 37, which are illustrated in FIG. 7. Note that some or all of these functional units may be implemented by dedicated hardware components.

The receipt length storage unit 31 stores the receipt lengths 42 of a predetermined number of receipts 5, on which purchase details are printed, in the receipt length record table 123. The receipt length storage unit 31 is an example of a storage unit in the present disclosure. It is preferable that the receipt length storage unit 31 stores only the receipt lengths 42 of receipts 5 on which actual purchase details are printed. That is, it is desirable that the receipt lengths 42 of receipts 5 on which actual purchase details are not printed, e.g., receipts 5 used for test printing, are not stored in the receipt length record table 123. For example, the receipt printer 10 may be configured to record the types of receipts 5, such as “purchase receipt” indicating receipts 5 for actual purchase and “non-purchase receipt” indicating receipts 5 printed for other purposes. In this case, the receipt length storage unit 31 reads the type of a printed receipt 5 and does not store the receipt length 42 of the printed receipt 5 in the receipt length record table 123 when the printed receipt 5 is a non-purchase receipt for, for example, test printing. In other words, the receipt length storage unit 31 identifies the type of the printed receipt 5 and determines whether to update the receipt length record table 123 with the receipt length 42 of the printed receipt 5 based on the identified type of the printed receipt 5.

The average receipt length calculation unit 32 calculates an average receipt length, which is the mean value of the receipt lengths 42 of the predetermined number of printed receipts 5 stored in the receipt length record table 123. The average receipt length calculation unit 32 is an example of a calculation unit in this disclosure.

The maximum printing speed determination unit 33 determines the maximum conveying speed of the receipt sheet 18 based on the calculated average receipt length when the next receipt 5 is printed. The maximum printing speed determination unit 33 is an example of a first determination unit in this disclosure.

The print data acquisition unit 34 acquires print data necessary for printing the next receipt 5 from, for example, a POS terminal connected to the receipt printer 10.

The printing speed determination unit 35 determines, for each line of the next receipt 5, a printing speed that corresponds to the number of dots to be printed in the line and is within the range not exceeding the maximum conveying speed determined by the maximum printing speed determination unit 33. The printing speed determination unit 35 is an example of a second determination unit in this disclosure.

The print execution unit 36 prints one line of the print data in the main-scanning direction of the receipt sheet 18. The print execution unit 36 conveys the receipt sheet 18, on which one line of the print data has been printed, by one line at the conveying speed determined by the printing speed determination unit 35. The print execution unit 36 also determines whether the printing of the receipt 5 has been completed.

The receipt length calculation unit 37 calculates the receipt length 42 of the receipt 5 printed by the receipt printer 10.

In the present embodiment, the average receipt length calculation unit 32 calculates the average receipt length, which is the mean value of the receipt lengths 42 of the predetermined number of receipts 5 stored in the receipt length record table 123, and the maximum printing speed determination unit 33 determines the maximum conveying speed of the receipt sheet 18 for printing the next receipt 5 based on the average receipt length. However, the statistical value of the receipt lengths 42 of printed receipts 5 used by the receipt printer 10 is not limited to the average receipt length.

The receipt printer 10 may calculate the median value or the mode value of the receipt lengths 42 of a predetermined number of printed receipts 5 instead of calculating the average receipt length. The median value is the receipt length located at the center in the distribution of the receipt lengths 42 of the predetermined number of printed receipts 5. For example, when 100 receipt lengths 42 are recorded in the receipt length record table 123, the median value is the mean value of the 50th receipt length from the top and the 51st receipt length from the top. The mode value is the receipt length that appears most frequently in the distribution of the receipt lengths 42 of the predetermined number of printed receipts 5. The receipt printer 10 may determine the maximum conveying speed of the receipt sheet 18 for printing the next receipt 5 based on the mean value, the median value, or the mode value. That is, the average receipt length calculation unit 32 can be referred to as a functional component that calculates a representative receipt length based on the receipt lengths 42 of the predetermined number of printed receipts 5. Using the median value or the mode value of the receipt lengths 42 of the predetermined number of printed receipts 5 makes it possible to calculate a proper representative receipt length even when extremely short receipt lengths or extremely long receipt lengths are included in the distribution of the receipt lengths 42 of the predetermined number of printed receipts 5.

### Flow of Process Performed by Receipt Printer

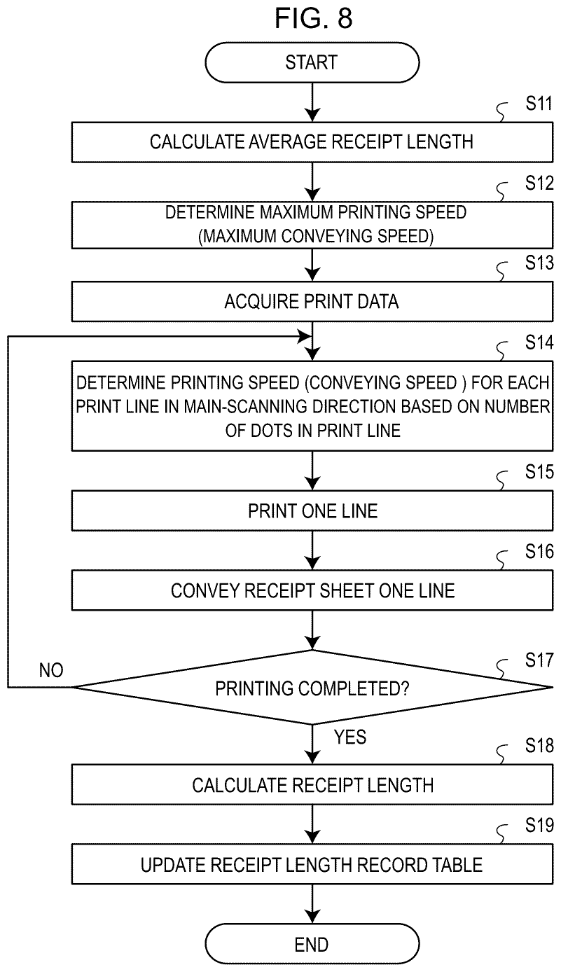

An example of a process performed by the receipt printer 10 will be described with reference to FIG. 8. FIG. 8 is a flowchart illustrating an example of a process performed by the receipt printer 10 according to the embodiment. The processor (CPU 111) of the receipt printer 10 may be configured to execute a program stored in a memory (e.g., the RAM 113 or the storage unit 12) to perform the steps in the process described below.

The average receipt length calculation unit 32 calculates an average receipt length, which is the mean value of the receipt lengths 42 of a predetermined number of printed receipts 5 stored in the receipt length record table 123 (step S11). At step S11, a representative receipt length, which is the mean value, the median value, or the mode value of the receipt lengths 42, may instead be calculated.

The maximum printing speed determination unit 33 determines the maximum conveying speed of the receipt sheet 18 for printing the next receipt 5 (or a receipt to be printed) based on the average receipt length (or the representative receipt length) (step S12).

The print data acquisition unit 34 acquires print data necessary to print the next receipt 5 from, for example, a POS terminal connected to the receipt printer 10 (step S13).

The printing speed determination unit 35 determines, for each print line of the next receipt 5 extending in the main-scanning direction, a printing speed (or a conveying speed of the receipt sheet 18) that corresponds to the number of print dots in the print line and is within the range not exceeding the maximum conveying speed determined by the maximum printing speed determination unit 33 (step S14). The printing speed determination unit 35 may calculate the number of print dots in the print line before step S14.

The print execution unit 36 prints one line of the print data on the receipt sheet 18 (step S15).

The print execution unit 36 conveys the receipt sheet 18, on which one line of the print data has been printed, by one line at the conveying speed determined by the printing speed determination unit 35 (step S16). In other words, the print execution unit 36 may control the platen roller drive motor 23 to rotate the platen roller 20 to convey the receipt sheet 18 one line at the determined conveying speed.

The print execution unit 36 determines whether the printing of the receipt 5 has been completed (step S17). When it is determined that the printing of the receipt 5 has been completed (step S17: Yes), the process proceeds to step S18. On the other hand, when it is determined that the printing of the receipt 5 has not been completed (step S17: No), the process returns to step S14.

When it is determined at step S17 that the printing of the receipt 5 has been completed, the receipt length calculation unit 37 calculates the receipt length 42 of the printed receipt 5 (step S18).

The receipt length storage unit 31 updates the receipt length record table 123 by replacing the oldest receipt length 42 in the receipt length record table 123 with the receipt length 42 calculated at step S18 (step S19). Then, the receipt printer 10 ends the process.

As described above, the receipt printer 10 (or printer) of the embodiment includes the receipt length storage unit 31 (or storage unit) that stores receipt lengths 42 of a predetermined number of receipts 5 on which purchase details are printed, the average receipt length calculation unit 32 (or calculation unit) that calculates the average receipt length (or representative receipt length) based on the receipt lengths 42 of the predetermined number of receipts 5, and the maximum printing speed determination unit 33 (or first determination unit) that determines the maximum conveying speed of the receipt sheet 18 for printing the next receipt 5 based on the average receipt length 43. This configuration makes it possible to keep the conveying speed of the receipt sheet 18 low when the expected receipt length 42 is short and thereby makes it possible to reduce the load on the thermal head 25. Also, when a receipt is short, the receipt issuing time will not increase much even if the printing speed is kept low. Accordingly, the above configuration makes it possible to achieve both a reduction in the receipt printing time and an extension of the lifetime of the thermal head 25 (or print head).

The receipt printer 10 (or printer) of the embodiment further includes the printing speed determination unit 35 (or second determination unit) that determines, for each line of a receipt 5 to be printed next, a printing speed that corresponds to the number of dots to be printed in the line and is within the range not exceeding the maximum conveying speed. This makes it possible to perform printing at a speed as high as possible within the range of the maximum power consumption of the receipt printer 10.

In the receipt printer 10 (or printer) according to the embodiment, the representative receipt length is the mean value, the median value, or the mode value of the receipt lengths 42 of the predetermined number of printed receipts 5 stored in the receipt length storage unit 31 (or storage unit). This makes it possible to calculate an appropriate representative receipt length even when the receipts 5 printed by the receipt printer 10 include extremely short receipts 5 or extremely long receipts 5.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a roller that conveys a recording medium;
a motor that rotates the roller;
a print head that prints receipts on the recording medium conveyed by the roller;
a storage device that stores receipt length information including receipt lengths of a predetermined number of printed receipts;
a memory; and
a processor configured to execute a program that is stored in the memory to perform the steps of:
calculating a representative receipt length based on the receipt lengths in the receipt length information,
determining a maximum conveying speed of the recording medium for a receipt to be printed based on the representative receipt length, and
controlling the motor to rotate the roller to convey the recording medium based on the maximum conveying speed.

2. The printer according to claim 1, wherein
the representative receipt length is a mean value, a median value, or a mode value of the receipt lengths in the receipt length information.

3. The printer according to claim 1, wherein
the steps further include
calculating a number of dots to be printed in a line of the receipt, and
determining, for the line of the receipt, a conveying speed that corresponds to the calculated number of dots and is within a range not exceeding the maximum conveying speed; and
the motor is controlled to rotate the roller to convey the recording medium one line at the determined conveying speed.

4. The printer according to claim 3, wherein the conveying speed is decreased as the number of dots increases and is increased as the number of dots decreases within the range not exceeding the maximum conveying speed.

5. The printer according to claim 1, wherein
the storage device also stores maximum conveying speed information including maximum conveying speeds that are associated with representative receipt length ranges specifying ranges of the representative receipt length; and
the maximum conveying speed is determined based on the representative receipt length and the maximum conveying speed information.

6. The printer according to claim 5, wherein the maximum conveying speed information is set such that the maximum conveying speed decreases as the representative receipt length decreases.

7. The printer according to claim 1, wherein the steps further include
calculating a receipt length of the receipt when printing of the receipt is completed, and
updating the receipt length information by replacing an oldest receipt length in the receipt length information with the calculated receipt length.

8. The printer according to claim 7, wherein the receipt length is calculated by totaling amounts of the recording medium conveyed for each line of the receipt.

9. The printer according to claim 7, wherein the steps further include
identifying a type of the receipt, and
determining whether to update the receipt length information with the calculated receipt length based on the identified type of the receipt.

10. The printer according to claim 1, wherein the receipt length information also includes print counts associated with the receipt lengths, each of the print counts indicating a cumulative number of printed receipts.

11. A method performed by a printer including a roller that conveys a recording medium and a print head that prints receipts on the recording medium conveyed by the roller, the method comprising:
calculating a representative receipt length based on receipt lengths of a predetermined number of printed receipts included in receipt length information stored in the printer;
determining a maximum conveying speed of the recording medium for a receipt to be printed based on the representative receipt length; and
rotating the roller to convey the recording medium based on the maximum conveying speed.

12. The method according to claim 11, wherein
the representative receipt length is a mean value, a median value, or a mode value of the receipt lengths in the receipt length information.

13. The method according to claim 11, further comprising:
calculating a number of dots to be printed in a line of the receipt; and
determining, for the line of the receipt, a conveying speed that corresponds to the calculated number of dots and is within a range not exceeding the maximum conveying speed,
wherein the roller is rotated to convey the recording medium one line at the determined conveying speed.

14. The method according to claim 13, wherein the conveying speed is decreased as the number of dots increases and is increased as the number of dots decreases within the range not exceeding the maximum conveying speed.

15. The method according to claim 11, wherein
the printer also stores maximum conveying speed information including maximum conveying speeds that are associated with representative receipt length ranges specifying ranges of the representative receipt length; and
the maximum conveying speed is determined based on the representative receipt length and the maximum conveying speed information.

16. The method according to claim 15, wherein the maximum conveying speed information is set such that the maximum conveying speed decreases as the representative receipt length decreases.

17. The method according to claim 11, further comprising:
calculating a receipt length of the receipt when printing of the receipt is completed; and
updating the receipt length information by replacing an oldest receipt length in the receipt length information with the calculated receipt length.

18. The method according to claim 17, wherein the receipt length is calculated by totaling amounts of the recording medium conveyed for each line of the receipt.

19. The method according to claim 17, further comprising:
identifying a type of the receipt; and
determining whether to update the receipt length information with the calculated receipt length based on the identified type of the receipt.

20. A non-transitory computer readable storage medium storing a program for causing a processor of a printer to perform a process,
the printer including a roller that conveys a recording medium and a print head that prints receipts on the recording medium conveyed by the roller,
the process including:
calculating a representative receipt length based on receipt lengths of a predetermined number of printed receipts included in receipt length information stored in the printer;
determining a maximum conveying speed of the recording medium for a receipt to be printed based on the representative receipt length; and
rotating the roller to convey the recording medium based on the maximum conveying speed.
